(19) United States
(12) Patent Application Publication
(10) Pub. No.: US 2006/0062897 A1
(43) Pub. Date: Mar. 23, 2006

(54) Patterned wafer thickness detection system

(75) Inventors: Yuping Gu, San Jose, CA (US); Manoocher Birang, Los Gatos, CA (US); Arulkumar Shanmugasundram, Sunnyvale, CA (US); Dmitry Lubomirsky, Cupertino, CA (US); Joseph J. Stevens, San Jose, CA (US)

Correspondence Address: PATTERSON & SHERIDAN, LLP, 3040 POST OAK BOULEVARD, SUITE 1500, HOUSTON, TX, 77056, US

(73) Assignee: APPLIED MATERIALS, INC

(21) Appl. No.: 11/034,349

(22) Filed: Jan. 11, 2005

Related U.S. Application Data
(63) Continuation-in-part of application No. 10/944,228, filed on Sep. 17, 2004.

(51) Int. Cl. B05D 3/12

(52) U.S. Cl. 427/8; 427/421.1; 427/240

(57) ABSTRACT

An apparatus and a method of controlling an electroless deposition process by directing electromagnetic radiation towards the surface of a substrate and detecting the change in intensity of the electromagnetic radiation at one or more wavelengths reflected off features on the surface of the substrate is provided. In one embodiment, the detected end of an electroless deposition process step is measured while the substrate is rotated relative to the detection mechanism. In another embodiment, a detection mechanism, which is proximate to the processing region, directs electromagnetic radiation onto a substrate surface, which is then reflected by features on the substrate surface and is detected by the detection mechanism. In one aspect, the angle of the directed electromagnetic radiation is perpendicular to the surface of the substrate and the shape of the directed electromagnetic radiation spot is substantially circular in shape. In another aspect, the directed electromagnetic radiation spot is positioned at the center of rotation of the substrate. A controller can be used to monitor, store, and/or control the electroless deposition process by use of stored process values, comparison of data collected at different times, and various calculated time dependent data.

### CROSS-REFERENCE TO RELATED APPLICATIONS

This application is a continuation-in-part of co-pending U.S. patent application Ser. No. 10/944,228, filed Sep. 17, 2004, entitled “Apparatus and Method of Detecting The Electroless Deposition Endpoint,” [Attorney Docket No. 8651] and is herein incorporated by reference.

### BACKGROUND OF THE INVENTION

1. Field of the Invention

The present invention generally relates to an apparatus and method of monitoring the deposition process of a conductive material over sub-micron apertures formed on a substrate.

2. Description of the Related Art

Reliably producing sub-micron and smaller features is one of the key technologies for the next generation of very large scale integration (VLSI) and ultra large scale integration (ULSI) semiconductor devices. However, as the boundaries of circuit technology are pressed, the shrinking dimensions of interconnects in VLSI and ULSI technologies have placed additional demands on the processing capabilities and consistent uniform control of the device formation process. The multilevel interconnects that lie at the heart of these technologies requires precise processing of complex features such as single or dual damascene structures and high aspect ratio features, such as vias and other interconnects. Reliable formation of these interconnects and reliable connection of these features to other devices is very important to VLSI and ULSI success and to the continued effort to increase circuit density and device yield of individual substrates.

Semiconductor processing generally involves the deposition of material onto and removal (“etching”) of material from substrates. Typical deposition processes include chemical vapor deposition (CVD), physical vapor deposition (PVD), electroplating, and electroless plating. Removal processes include chemical mechanical planarization (CMP), etching and others. During the processing and handling of substrates, the substrates undergo various structural and chemical changes. Illustrative changes include the thickness of layers disposed on the substrate, the material of layers formed on the substrate, surface morphology, changes in the device patterns, etc. These changes must be controlled in order to produce the desired electrical characteristics of the devices formed on the substrate. In the case of etching, for example, end-point detection methods are used to determine when the requisite amount of material has been removed from the substrate. More generally, successful processing requires ensuring the correct process recipe, controlling process excursions (e.g., gas flow, temperature, pressure, electromagnetic energy, duration, etc.) and the like.

Currently, copper and its alloys have become the metals of choice for sub-micron interconnect technology, because copper has a lower resistivity than aluminum, (1.7 μΩ-cm compared to 3.1 μΩ-cm for aluminum), a higher current carrying capacity, and a significantly higher electromigration resistance. These characteristics are important for supporting the higher current densities required for the high levels of integration and increased device speed. Copper can be deposited by various techniques such as PVD, CVD and electroplating.

Typical device features utilizing copper or copper alloys are single damascene or dual damascene processes. In damascene processes, a feature is etched in a dielectric material and subsequently filled with copper. A barrier layer is deposited conformally on the surfaces of the features formed in the dielectric layer prior to deposition of the copper. Copper is then deposited over the barrier layer and the surrounding field. As layers of materials are sequentially deposited and removed, the uppermost surface of the substrate may become non-planar across its surface and require planarization. Planarizing a surface, or “polishing” a surface, is a process where material is removed from the surface of the substrate to form a generally even, planar surface. Planarization is useful in removing undesired surface topography and surface defects, such as rough surfaces, agglomerated materials, crystal lattice damage, scratches, and contaminated layers or materials. Planarization is also useful in forming features on a substrate by removing excess deposited material used to fill the features and to provide an even surface for subsequent levels of metallization and processing.

Chemical mechanical planarization, or chemical mechanical polishing (CMP), is a common technique used to planarize substrates. CMP utilizes a chemical composition, typically a slurry or other fluid medium, for selective removal of material from substrates. In conventional CMP techniques, a substrate carrier or polishing head is mounted on a carrier assembly and positioned in contact with a polishing pad in a CMP apparatus. The carrier assembly provides a controllable pressure to the substrate urging the substrate against the polishing pad. The pad is moved relative to the substrate by an external driving force. The CMP apparatus effects polishing or rubbing movement between the surface of the substrate and the polishing pad while dispersing a polishing composition, or slurry, to effect chemical activity and/or mechanical activity and consequential removal of material from the surface of the substrate.

After the surface of the substrate has been planarized the surface will generally comprise an array of exposed features and a “field area” comprising some form of dielectric material that electrically isolates the features from one another. The exposed features may contain such interconnecting metals as copper, aluminum or tungsten and barrier materials such as tantalum, tantalum nitride, titanium, titanium nitride, cobalt, ruthenium, molybdenum, etc.

Even though copper has been selected as one of the favorite interconnection materials, it has a couple drawbacks. Namely, it is difficult to etch, it has a tendency to form a stable oxide layer when exposed to the atmosphere, and can form various corrosion products when exposed to other aggressive semiconductor fabrication environments. The formation of the stable oxide layer can greatly affect the reliability of the connections. To resolve this problem, various methods have been employed to deposit a more inert metallic layer, or capping layer, over the interconnecting materials to reduce the oxidation of the surface or the subsequent attack of the exposed layers. The capping layer can be deposited by physical vapor deposition (PVD), molecular beam epitaxy (MBE), chemical vapor deposition (CVD), atomic layer deposition (ALD) or electroless deposition processes. Since PVD, CVD, ALD and MBE will indiscriminately and not selectively deposit the capping layer material across the surface of the substrate, subsequent polishing or patterning and etching will be required to electrically isolate the exposed features. The added steps of polishing, pattering and etching adds great complexity to the device forming process. Therefore, electroless deposition processes are often preferred.

Although electroless deposition techniques have been widely used to deposit conductive metals over non-conductive printed circuit boards, electroless deposition techniques have not been extensively used for forming interconnects in VLSI and ULSI semiconductors. Electroless deposition involves an autocatalyzed chemical deposition process that does not require an applied current for the reaction to occur. Electroless deposition typically involves exposing a substrate to a solution by immersing the substrate in a bath or by spraying the solution over the substrate. Deposition of a conductive material in micron technology by electroless or electroplating techniques requires a surface capable of electron transfer for nucleation of the conductive material to occur over that surface. Non-metal surfaces and oxidized surfaces are examples of surfaces which cannot participate in electron transfer. Barrier layers comprising titanium, titanium nitride, tantalum, and/or tantalum nitride are poor surfaces for nucleation of a subsequently deposited conductive material layer, since native oxides of these barrier layer materials are easily formed.

One issue that arises with the use of an electroless deposition process is the effect that surface contamination or oxidation has on the time it takes the electroless deposition process to begin or initiate. This time, often known as the initiation time, is strongly dependent on the ability of the catalytic layer fluid or deposition fluid to interact with the surface of the interconnect feature. Once the electroless reaction has initiated, the time to deposit a defined amount of material is predictable and will generally fall into a relatively repeatable range of deposition rates. However, since there is no way to know when the process has initiated and the initiation time varies from substrate to substrate or from one area of a substrate to another, it is hard to know when the desired thickness of material has been deposited across the surface of the substrate. To compensate for this type of process variation, engineers will often use a worst case processing time to assure that a desired amount of material is deposited across the surface of the substrate or from one substrate to another. Use of a processing time that is close to the worst case processing time causes the throughput of the deposition chamber to suffer and results in the waste of the expensive electroless deposition solutions. Also, variations in thickness of the deposited film across the surface of the substrate and/or the variations substrate-to-substrate will cause variations in the processing speed (e.g., propagation delay) of the formed devices. The variation in speed of the formed devices, created by the variation in resistance (i.e., varying thickness) can have a significant affect on device yield.

Various process monitoring techniques have been employed to monitor and control the electroless deposition process so that a repeatable and reliable process result can be achieved. Typical process monitoring techniques that have been employed are, for example, an optical monitoring technique, a film resistance measurement technique and an eddy current measurement technique. Film resistance measurement and eddy current techniques both require a continuous or large area from which to collect reliable measurements, which are often not available at various stages of the electronic device fabrication process, such as, after planarization of a metal layer using a CMP process. The use of optical detection methods also have issues where the optical detection methods are used to monitor a process that is being performed on a surface that contains an array of exposed features that vary in density across the surface. The phrases or terms, varying density of the surface features or surface feature density, are generally intended to describe a case where the surface area of the exposed reflective features on the surface of a substrate varies from one region of the substrate to another. The complexity associated with optical detection techniques arises since the density of the exposed features directly affects the intensity of the detection signal reflected off of the substrate surface and the signal-to-noise-ratio of the detected signal. These complications can cause the detected signal intensity to vary as the detection area (or viewing area) from which the electromagnetic radiation is reflected is moved across the non-planar, irregular shaped, or varying density features on the substrate surface. The term signal-to noise ratio is used to describe the ratio of the strength of the wanted signal received by the optical detector versus the strength of the background noise received by the optical detector. The larger the signal-to-noise ratio the easier it is to separate the true signal from the unwanted noise present in the detection system, and thus the more confidence one can have in the collected data. The variability in intensity and the increased signal-to-noise ratio makes it harder to monitor the electroless deposition process and achieve repeatable, reliable, and measurable results.

Process monitoring techniques in general require the sensing component of the system to be placed near or interact with the surface of the substrate in some way. The interaction of the process monitoring hardware with corrosive vapors and the its interference with the laminar flow of air across the surface of the substrate during processing can affect the reliability of the measurement technique and affect device yield due to direct or indirect contamination of the substrate surface.

Therefore, there is a need for an improved apparatus and method for reliably monitoring and detecting the state of an electroless deposition process on substrates that have a varying density of features on the surface thereof, which will not affect device yield.

### SUMMARY OF THE INVENTION

Aspects of the invention provide an apparatus for monitoring an electroless deposition process to determine the end of an electroless process step. The apparatus includes a plurality of chamber walls that enclose a processing region, a substrate support disposed in the processing region having a substrate receiving surface, an electromagnetic radiation source that is mounted proximate to the processing region and is adapted to emit electromagnetic radiation that strikes a surface of a substrate mounted on the substrate receiving surface at an angle that is substantially perpendicular to the substrate surface, a detector that is mounted proximate to the processing region and is adapted to detect the intensity of reflected electromagnetic radiation from the surface of the substrate during an electroless deposition process, and a controller adapted to receive a signal from the detector and to modify the electroless deposition process.

In another aspect of the invention an apparatus for monitoring an electroless deposition process comprises a plurality of chamber walls that enclose a processing region, a substrate support disposed in the processing region having a substrate receiving surface, a mirror mounted in the processing region, an electromagnetic radiation source that is mounted proximate to the processing region and is adapted to emit electromagnetic radiation that strikes the mirror and the mirror reflects the electromagnetic radiation towards a surface of a substrate mounted on the substrate receiving surface, a detector that that is mounted proximate to the processing region and is adapted to detect the intensity of reflected electromagnetic radiation from the surface of the substrate during an electroless deposition process, and a controller adapted to receive a signal from the detector and modify the electroless deposition process.

In another aspect of the invention an apparatus for monitoring an electroless deposition process comprises a plurality of chamber walls that enclose a processing region, a substrate support disposed in the processing region having a substrate receiving surface, a drive mechanism that can rotate the substrate support, an electromagnetic radiation source that is mounted proximate to the processing region and is adapted to emit electromagnetic radiation at a wavelength between about 660 nanometers (nm) and about 680 nm that is in communication with a center of rotation on a surface of a substrate mounted on the substrate receiving surface at an angle that is substantially perpendicular to the substrate receiving surface, a detector that that is mounted proximate to the processing region and is adapted to detect the intensity of reflected electromagnetic radiation at a wavelength between about 660 nanometers (nm) and about 680 nm from the surface of the substrate during an electroless deposition process, and a controller adapted to receive a signal from the detector and to modify the electroless deposition process.

In another aspect of the invention, a system for monitoring an electroless deposition process comprises a plurality of chamber walls that enclose a processing region, a substrate support disposed in the processing region having a substrate receiving surface, an electromagnetic radiation source that is mounted proximate to the processing region and is adapted to emit electromagnetic radiation that strikes a surface of a substrate mounted on the substrate receiving surface, a detector that detects the intensity of the reflected electromagnetic radiation from the surface of a substrate mounted on the substrate receiving surface during an electroless deposition process, a controller adapted to receive a signal from the detector and modify the electroless deposition process, and a memory, coupled to the controller, the memory comprising a computer-readable medium having a computer-readable program embodied therein for directing the operation of the electroless deposition system, the computer-readable program comprising: computer instructions to control the electroless deposition system to: start processing; collect and store into the memory the intensity of the reflected electromagnetic radiation data during the electroless deposition process; compare the stored data with the collected data; and modify the electroless deposition process when the collected data exceeds a threshold value.

Aspects of the invention further provide a method of controlling an electroless deposition process by positioning a substrate in an electroless deposition chamber, rotating the substrate, emitting electromagnetic radiation from a broadband light source onto the a surface of the substrate, wherein the shape of the emitted electromagnetic radiation striking the surface of the substrate is substantially circular and the emitted electromagnetic radiation striking the surface of the substrate is positioned at a center of rotation of the substrate, detecting an intensity of the electromagnetic radiation at one or more wavelengths that is reflected off a surface of a substrate during an electroless deposition process step by use of a detector, and monitoring the intensity of the electromagnetic radiation at the one or more wavelengths to determine the status of the electroless deposition process.

Aspects of the invention further provide a method of controlling an electroless deposition process by delivering an electroless deposition fluid to a substrate in an electroless deposition chamber, detecting the intensity of the electromagnetic radiation comprising: rotating the substrate; emitting electromagnetic radiation from a broadband light source onto the a surface of the substrate, wherein the shape of the emitted electromagnetic radiation striking the surface of the substrate is substantially circular and the emitted electromagnetic radiation striking the surface of the substrate is positioned at a center of rotation of the substrate; and detecting an intensity of the electromagnetic radiation at one or more wavelengths reflected off a surface of a substrate, comparing the detected intensity of the electromagnetic radiation at a first time with a detected intensity of the electromagnetic radiation at a second time, starting a deposition timer when the difference between the intensity of the electromagnetic radiation at the first time and the intensity of the electromagnetic radiation at the second time equals a process value, and modifying an electroless deposition process step after the deposition timer has reached a defined period of time.

Aspects of the invention provide a method of controlling an electroless deposition process by positioning a substrate in an electroless deposition chamber, rotating the substrate, emitting electromagnetic radiation from a broadband light source onto a surface of the substrate, wherein the shape of the emitted electromagnetic radiation striking the surface of the substrate is substantially circular and the emitted electromagnetic radiation striking the surface of the substrate is positioned at a center of rotation of the substrate, detecting an intensity of the electromagnetic radiation at one or more wavelengths that is reflected off a surface of a substrate at the start of the electroless deposition process by use of a detector, detecting an intensity of the electromagnetic radiation at one or more wavelengths that is reflected off a surface of a substrate at a second time by use of a detector, and modifying an electroless deposition process step when the change in the detected intensity at one or more wavelengths exceed a desired level.

In another aspect of the invention an apparatus for monitoring an electroless deposition process comprises a plurality of chamber walls that enclose a processing region, a substrate support disposed in the processing region having a substrate receiving surface, a motor adapted to rotate the substrate support, wherein the substrate support has an axis of rotation that is substantially perpendicular to the substrate receiving surface, an electromagnetic radiation source that is adapted to emit electromagnetic radiation that is substantially directed towards a center point on a substrate retained on the substrate receiving surface, wherein the center point is coincident with the axis of rotation, a detector that is adapted to detect the intensity of reflected electromagnetic radiation from a surface of the substrate during an electroless deposition process, and a controller adapted to receive a signal from the detector and modify the electroless deposition process.

In another aspect of the invention, an apparatus for monitoring an electroless deposition comprises a plurality of chamber walls that enclose a processing region, a substrate support disposed in the processing region having a substrate receiving surface, a motor adapted to rotate the substrate support, an electromagnetic radiation source that is adapted to emit electromagnetic radiation that strikes a substrate retained on the substrate receiving surface, an anamorphic prism that is adapted to distort the shape of the electromagnetic radiation emitted from the electromagnetic radiation source, a detector that is adapted to detect the intensity of reflected electromagnetic radiation from a surface of the substrate during an electroless deposition process, and a controller adapted to receive a signal from the detector and modify the electroless deposition process.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIGS. 1A-1C are schematic cross-sectional views of a feature processed using embodiments of the present invention.

FIG. 2A is a schematic cross-sectional view of a face-up electroless processing chamber used with aspects of the invention.

FIG. 2B is a schematic cross-sectional view of a face-up electroless processing chamber used with aspects of the invention.

FIG. 2C is a schematic cross-sectional view of a face-down electroless processing chamber used with aspects of the invention.

FIG. 3A is a schematic diagram of the viewing area of a detection mechanism on a substrate surface.

FIG. 3B is a schematic diagram of the viewing area of a detection mechanism on a substrate surface which contains features.

FIG. 3C is a plot of intensity versus time of a measured signal at a central position on the substrate and a measured signal at a off of the central position.

FIG. 3D is a plot of intensity versus time of a measured signal at a wavelength.

FIG. 4A is a schematic cross-sectional view of a face-up electroless processing chamber used with aspects of the invention.

FIG. 4B is a schematic cross-sectional view of a face-up electroless processing chamber used with aspects of the invention.

FIG. 4C is a schematic cross-sectional view of a face-down electroless processing chamber used with aspects of the invention.

FIG. 4D is a schematic cross-sectional view of a face-up electroless processing chamber used with aspects of the invention.

### DETAILED DESCRIPTION OF THE PREFERRED EMBODIMENTS

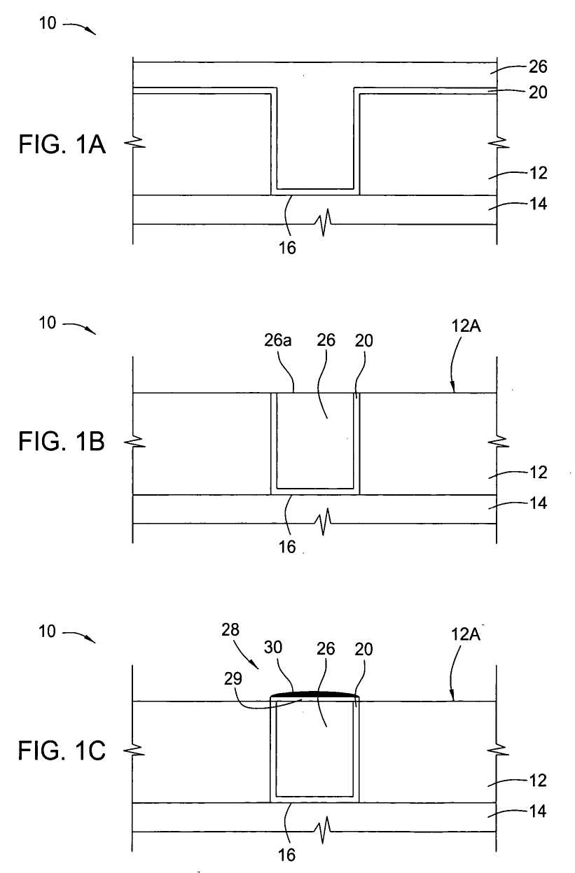

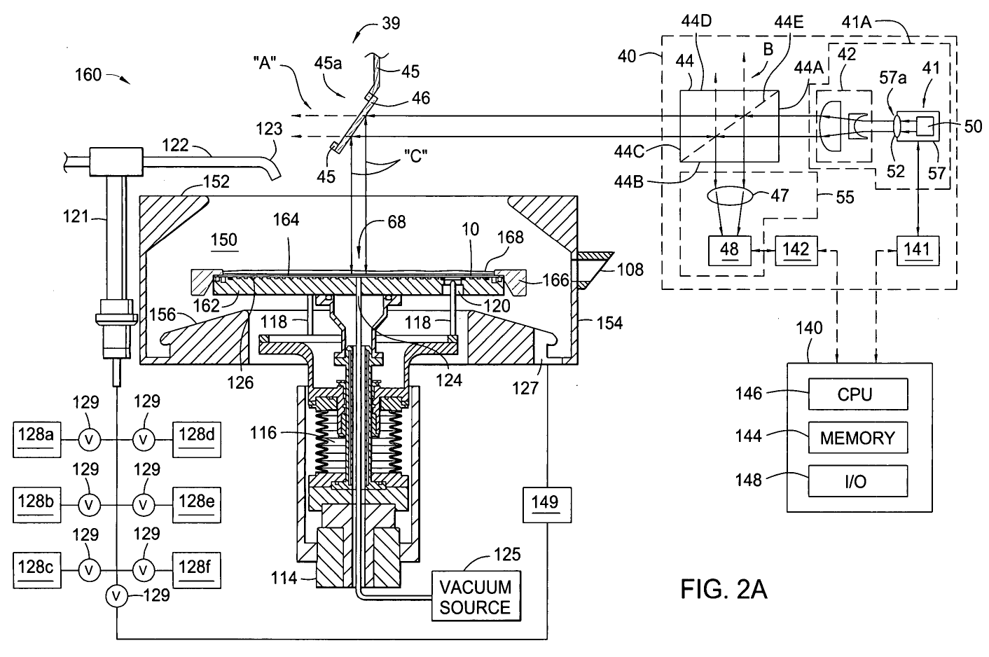

FIG. 1A illustrates a schematic cross-sectional view of a substrate base 14 formed on a substrate 10 and filled by a physical vapor deposition (PVD), Chemical vapor deposition (CVD), electrochemical deposition (ECP), electroless deposition, or a molecular beam epitaxy (MBE) process. The substrate 10 refers to any workpiece upon which film processing is performed. For example, the substrate 10 may be a silicon semiconductor substrate (or wafer), or other material layer that has been formed on the substrate. A dielectric layer 12 is deposited over the substrate. The dielectric layer 12 is generally an oxide, a silicon oxide, carbon-silicon-oxide, a fluoro-silicon, a porous dielectric, or other suitable dielectric material. The dielectric layer 12 is patterned to provide a feature 16, such as a via, trench, contact hole, or line extending to an exposed surface portion of the substrate base 14. It is also understood by those with skill in the art that the present invention may be used in a dual damascene process flow. The substrate 10 is used to denote the substrate base 14, as well as other material layers formed on the substrate base 14, such as the dielectric layer 12 and other subsequently deposited material layers.

FIG. 1A illustrates one method of filling the feature 16 including depositing a barrier layer 20 over the substrate base 14 and filling the remaining aperture by depositing a conductive material layer 26. The conductive material layer 26 may be deposited by electroless deposition, ECP, PVD, CVD, or a combination of electroless deposition followed by electroplating, PVD, or chemical vapor deposition. Depending the shape and size of the feature 16, the process of filling the feature 16 may be more complicated than what is shown in FIGS. 1A-1C, due to other process requirements that require additional layers to be formed to fill the feature 16. An example of layers found in a more complicated device are: a barrier layer, a seed layer, a catalytic layer (if electroless), an intermediate seed layer and/or the bulk conductive layer.

FIG. 1B generally shows the next major processing step including the planarization of the top portion of the filled features, which may be completed by a process such as chemical mechanical polishing. The planarization step may also be completed by an electrochemical planarization (ECMP) process where the use of mechanical, chemical, and/or electrochemical activity is used to remove the desired materials.

Since the feature surface 26a of the conductive material layer 26 is an interface used to electrically connect the devices in the current metal layer to subsequent metal layers placed on top of the current metal layer, any oxidation or contamination on the interface can affect the ability to make contact to the current metal layer and thus affect device yield. Therefore, a capping layer 28, as shown in FIG. 1C, which does not corrode in subsequent processes or allow an oxide layer to form on the feature surface 26a is needed. Since typical PVD, MBE, CVD, and ALD deposition processes will indiscriminately and not selectively deposit the capping layer material across the surface of the substrate (see items 12A and 26a), subsequent polishing or patterning and etching will be required to electrically isolate the exposed devices/features. Due to its ability to selectively deposit a film, electroless deposition processes are often preferred.

In one embodiment the capping layer 28 is a single electrolessly deposited layer (not shown). The capping layer 28 may be formed on the conductive portions of the substrate surface by depositing cobalt or a cobalt alloy. For example, useful cobalt alloys include cobalt-tungsten alloys, cobalt-phosphorus alloys, cobalt-tin alloys, cobalt-boron alloys, and also alloys, such as cobalt-tungsten-phosphorus (CoWP), cobalt-tungsten-boron (CoWB), and cobalt-tungsten-phosphorus-borane (CoWPB). The capping layer 28 in this embodiment may be deposited to a thickness of about 150 Å or less, such as between about 100 Å and about 200 Å.

In another embodiment the capping layer 28 may be made up of two or more deposited layers, such as a catalytic layer 29 and a conductive cap layer 30. A very thin catalytic layer 29 is first deposited to promote adhesion of the conductive cap layer 30 to the conductive material layer 26 and the barrier layer 20. In one embodiment the catalytic layer 29 is deposited by an electroless deposition process to promote adhesion to all layers in feature 16 except the barrier layer 20. The catalytic layer may be formed on the conductive portions of the substrate surface by depositing one or more noble metals thereon. The catalytic layer solution generally provides for the deposition of a noble metal to a thickness of about 50 Angstroms (Å) or less, such as about 10 Å or less. The noble metal may be palladium, platinum, gold, silver, iridium, rhenium, rhodium, ruthenium, osmium, or any combination thereof. Preferably, the noble metal is palladium.

A conductive cap layer 30 is next deposited on the exposed catalytic layer 29 by a selective electroless deposition process. Preferably, the conductive cap layer 30 includes cobalt or a cobalt alloy. For example, useful cobalt alloys include cobalt-tungsten alloys, cobalt-phosphorus alloys, cobalt-tin alloys, cobalt-boron alloys, and also alloys, such as cobalt-tungsten-phosphorus, cobalt-tungsten-boron and cobalt-tungsten-phosphorus-borane. The conductive cap layer may also include other metals and metal alloys, such as nickel, tin, titanium, tantalum, tungsten, molybdenum, platinum, iron, niobium, palladium, nickel cobalt alloys, doped cobalt, doped nickel alloys, nickel iron alloys, and combinations thereof. The conductive cap layer may be deposited to a thickness of about 150 Å or less, such as between about 100 Å and about 200 Å. The method and apparatus to deposit the capping layer is more fully described in the co-pending applications U.S. patent application Ser. No. 10/284,855 [AMAT 7081], entitled “Post Rinse To Improve Selective Deposition Of Electroless Cobalt on Copper For ULSI Application” filed on Oct. 30, 2002 and U.S. patent application Ser. No. 10/967,919 [AMAT 8660.02], entitled “Selective Self-Initiating Electroless Capping Of Copper With Cobalt-Containing Alloys” filed on Oct. 21, 2004, which are incorporated by reference herein to the extent not inconsistent with the claimed aspects and disclosure herein. The electroless deposition process steps incorporated by reference generally include the following process steps: pre-rinse, initiation layer deposition, rinse step, cap layer deposition, and post-cap layer deposition cleaning process. The pre-rinse step is designed to remove metal oxides or other contaminants on the substrate surface. “Substrate surface,” as used herein, refers to a layer of material that serves as a basis for subsequent processing operations that may contain any part of an interconnect feature (feature 16), such as a plug, via, contact, line, wire, etc., and one or more nonconductive materials (dielectric layer 12), such as silicon, doped silicon, germanium, gallium arsenide, glass, and sapphire, for example. The pre-rinse process may utilize an acidic solution, preferably 0.5 wt. % of HF, 1M nitric acid and the balance DI water at about 25° C., to remove/etch a top portion (e.g., about 10 Å to about 50 Å) of the substrate surface. The pre-rinse process further includes a DI water rinse step to remove any remaining pre-rinse solution, any etched materials and particles, and any by-products that may have formed during the prior pre-rinse steps. Following the pre-rinse process, an initiation layer is deposited on the substrate surface by selectively depositing about 50 Å or less of a noble metal, such as palladium, on the exposed conductive materials of the substrate surface. In one aspect, the initiation layer is deposited from an electroless solution containing at least one noble metal salt and at least one acid. A concentration of the noble metal salt within the initiation layer electroless solution should be between about 80 parts per million (ppm) and about 300 ppm. Exemplary noble metal salts include palladium chloride (PdCl₂), palladium sulfate (PdSO₄), palladium ammonium chloride, or combinations thereof. A rinsing process using a rinsing agent, such as deionized water, for example, is applied to the substrate surface to remove any solution used in forming the initiation layer. A passivation layer is next deposited on the exposed initiation layer by a selective electroless deposition process. Preferably, the passivation layer includes cobalt or a cobalt alloy deposited using a cobalt electroless solution containing 20 g/L of cobalt sulfate, 50 g/L of sodium citrate, 20 g/L of sodium hypophosphite, and a sufficient amount of potassium hydroxide to provide a pH of about 10. Following the passivation layer deposition, the substrate surface may be cleaned to remove unwanted portions of the passivating material by use of post-deposition cleaning process. A post-deposition cleaning solution may include, for example, a solution of sulfuric acid and DI water.

In another embodiment the chemistry for the electroless catalytic layer 29 and cap layer 30 deposition processes is supplied by a manufacturer such as, for example, Enthone, Inc., West Haven, Conn. One example of a typical catalytic layer 29 deposition chemistry used is the E-CoWP Activator 763-45 (palladium (Pd)) supplied by Enthone Inc. An exemplary catalytic layer deposition process using the E-CoWP Activator 763-45 chemistry is a 25 second room temperature deposition process which will deposit about 30 Angstroms of palladium (Pd). After depositing the catalytic layer 29 using the E-CoWP Activator 763-45 chemistry, a post deposition rinse agent, Cap Chelating Rinse 5X, for example, is used to activate the catalytic layer for subsequent cap layer 30 deposition. Next the ENCAP CoWP763-38A and ENCAP CoWP763-39B cap layer 30 chemistry, mixed to manufacturer's suggested proportions, is then used to deposit about 150 Angstroms of a CoWP cap layer on the activated catalytic layer 29. An exemplary capping layer deposition process using the two part ENCAP CoWP763-38A and CoWP763-39B chemistries is a 45 second and 75 degrees Celsius deposition process to deposit about 150 Angstroms of CoWP.

In another embodiment a self-initiating capping layer chemistry from Enthone Inc. is used to cap the feature surface 26a. An example, of a typical deposition chemistry is a two part CAPB764-75A and the CAPB764-75B chemistry supplied by Enthone Inc. The two part CAPB764-75A and the CAPB764-75B chemistry is mixed to manufacturer's suggested proportions, to deposit about 150 Angstroms of a CoWB capping layer. An exemplary process utilizing the two part CAPB764-75A and the CAPB764-75B chemistry is a 45 seconds and 65 degrees Celsius deposition process to deposit a 150 Angstrom CoWB film. A pre-clean solution CAPB cleaner, supplied by Enthone, is used prior to depositing the capping layer to remove any oxides from the feature surface 26a and prepare it for the subsequent deposition.

The method of electroless deposition of a catalytic layer and/or the method of electroless deposition of a conductive material layer may be performed in any chamber adapted to contact a substrate with a processing solution, such as electroless deposition chambers, electroplating chambers, etc. In one embodiment, the catalytic layer and the conductive material layer may be deposited in the same chamber. In another embodiment, the catalytic layer and the conductive material layer are deposited in separate chambers. In one aspect, depositing the catalytic layer and the conductive material layer in separate chambers reduces the generation of particles that may form and deposit on chamber components as a result of the reaction of the catalytic layer solutions and the conductive material layer solutions.

One issue that arises with the use of an electroless deposition process is the effect that even small amounts of surface contamination or oxidation have on the time it takes the electroless deposition process to “initiate” or begin depositing material. The time it takes the electroless deposition process to initiate, or the initiation time, can vary from substrate to substrate or from one area of the substrate to another. Variation in initiation time make it hard to know how much material has been deposited at any given instant of time or when a desired amount has been deposited. The variations in initiation time, as noted above, can be wasteful of the very expensive deposition solution(s), cause variations in device performance across the substrate and substrate-to-substrate, and can reduce the substrate throughput through the electroless deposition chamber. Also, to achieve a high throughput (substrates per hour) through the electroless deposition chamber the process times to deposit thin films may be very short, for example, about 10 seconds, therefore the need to monitor and control the electroless deposition process can be critical to the creation of devices with consistent device properties. In some cases extended exposure to one or more of the electroless deposition chemistry components will cause significant corrosion of one or more of the exposed substrate surfaces. Therefore, in one aspect of the invention it is important to find a way to minimize the exposure time of the surfaces to the one or more electroless deposition chemistry components to prevent any significant corrosion from occurring.

Process Monitoring

Therefore, one of the aspects of the present invention is a way to monitor and/or detect the point at which a desired thickness of material has been deposited on the surface of the substrate having surface features 26a of varying density. In general the present invention can be used to reliably detect and monitor changes due to a change in some characteristic of the feature surface 26a or the deposition of a desired material. The ability to monitor, store, and manipulate the collected data by a chamber controller can reduce the substrate-to-substrate variability and also reduce the amount of waste of the expensive deposition chemicals. Various embodiments described herein, utilize method of detecting and delivering data regarding the thickness of a deposited layer across the surface of a substrate as a function of time.

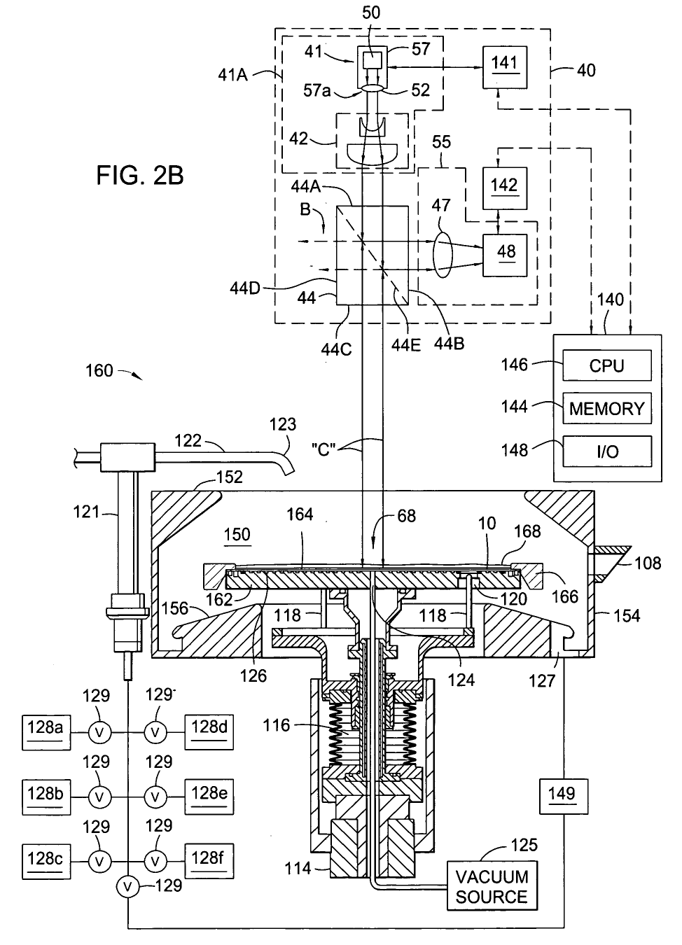

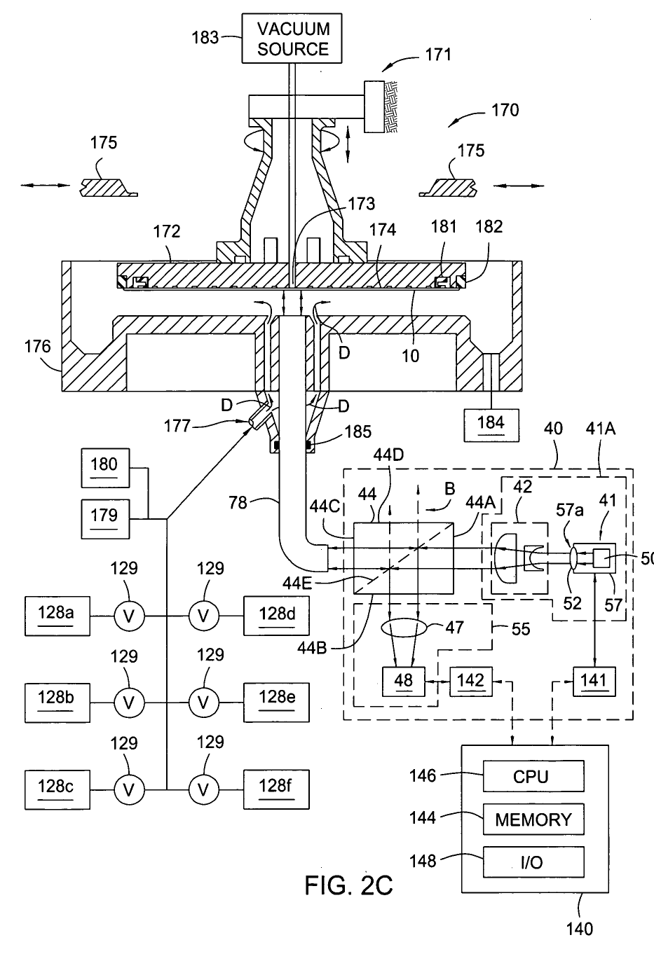

FIG. 2A illustrates one embodiment of the present invention that uses a detection mechanism 40 to monitor and feedback the state of the electroless deposition process as a function of time. To complete this goal the detection mechanism 40 is positioned such that it can monitor a change in the optical properties of the feature surface 26a during the electroless deposition process (e.g., catalytic layer deposition process, conductive cap layer deposition process, pre-rinse steps, rinse step, or post-cap layer cleaning process steps). The correlation of the change in the reflected radiation, or signal, at a particular wavelength to a change in a processing property, can be completed by characterization of the intensity signal with the growth of the deposited film, or change in its surface properties, by use of one or more test pieces prior to running the desired deposition process. In one embodiment, the electromagnetic radiation emitted from a broadband light source 41 passes through a deposition fluid, be reflected off the features on the surface of the substrate 10, pass through deposition fluid 168, and then be collected by a detector system 55.

The surface of the substrate 10, as noted above, may contain many filled features containing a conductive layer, a barrier layer, and a dielectric material. The light projected on to the surface of the substrate 10 by the broadband light source 41 will generally only be reflected from the exposed metal surfaces and not from the dielectric layer. Given the current state of technology it is believed that the exposed metal surfaces on the surface of the substrate after the planarization step will generally account for about 50% of the total surface area of the substrate (i.e., feature density).

Referring to FIG. 2A, the detection mechanism 40 generally includes an emission source 41A, source controller 141, a beam splitter 44, a detector system 55, and a detector controller 142, and a system controller 140. The emission source 41A generally contains a broadband light source 41 and a beam expander 42. Generally, when the detection mechanism is monitoring the surface of the substrate 10 the radiation emitted from the broadband light source 41 travels through the beam expander 42 where the emitted radiation is expanded and/or collimated. After exiting the beam expander the radiation enters one face of the beam splitter (see item 44A discussed below) where some percentage of the radiation of the emitted radiation is reflected by the coated surface 44E in a direction “B” (out face 44D) while the remaining percentage is passed directly through beam splitter 44 and out the opposing face 44C. After the emitted radiation exits the face 44C it strikes the mirror 46 and is reflected towards the surface of the substrate 10 (see item “C”). As noted below, in some aspect of the invention the mirror is designed to reflect only certain wavelengths and thus the other non-reflected wavelengths will pass through the mirror 46, as shown by arrows “A”. After the emitted radiation is reflected by the mirror 46 the radiation then strikes the surface of the substrate 10 which covers an area know as the viewing area 68. The emitted radiation is then reflected, scattered or absorbed at the surface of the substrate 10. A percentage of the reflected radiation then travels back to the mirror 46 where it is reflected towards the face 44C of the beam splitter 44. The reflected radiation then passes through the face 44C and strikes the coated surface 44E where a percentage of the reflected radiation is directed towards the detection mechanism 55 where the incident radiation is detected.

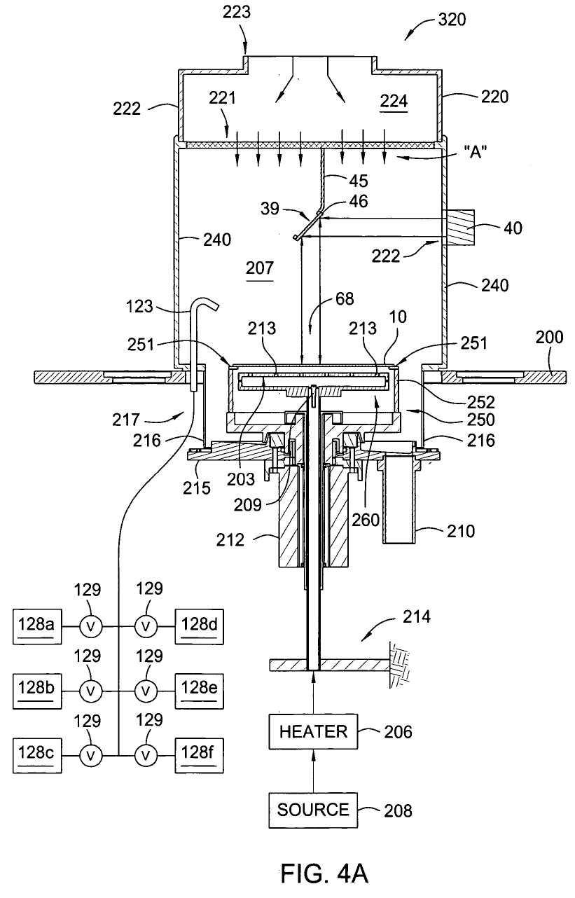

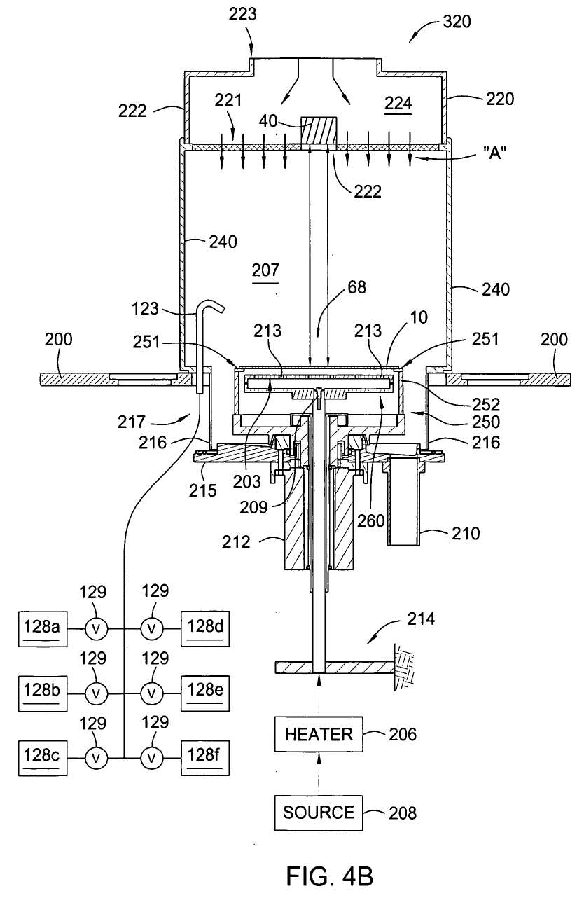

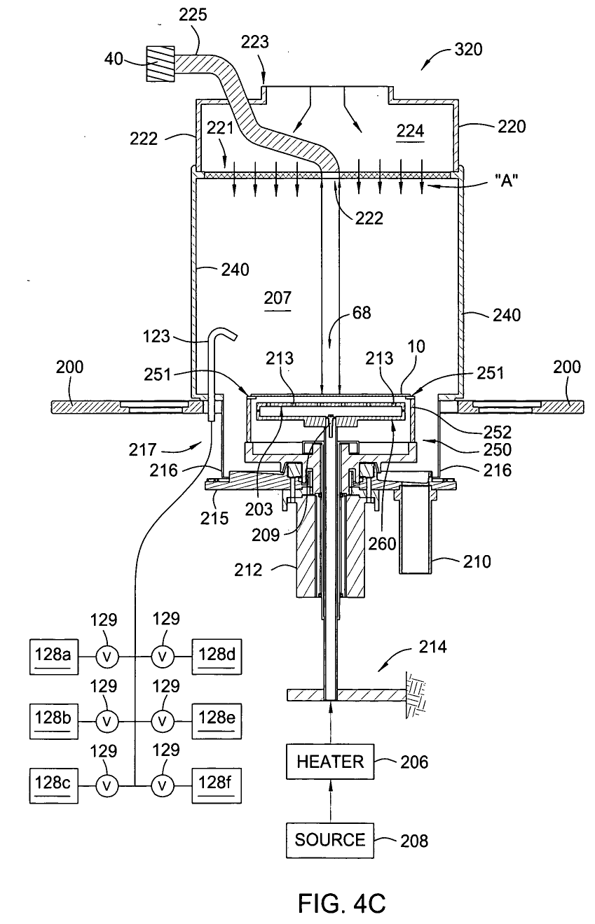

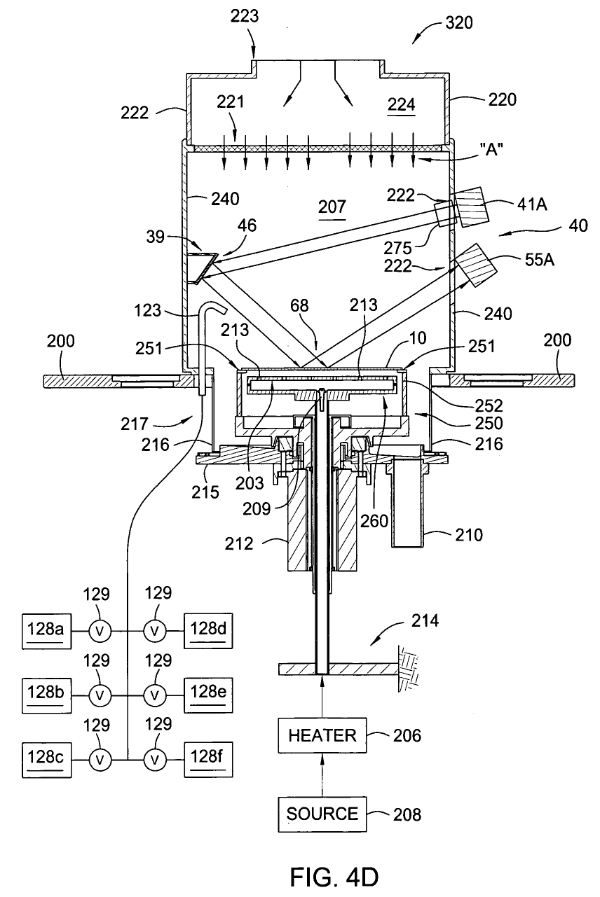

The embodiment illustrated in FIG. 2A allows the detection mechanism 40 to be positioned a distance away from the surface of the substrate and thus reduces the interaction of the detection mechanism 40 components with the processing environment. The reduced interaction of the detection mechanism 40 with the processing environment will reduce the interaction of the process detection mechanism 40 with any splashed liquid and corrosive vapors, and interference with the laminar flow of gases (e.g., air, nitrogen, argon, etc.) across the surface of the substrate. In one aspect, as shown in FIGS. 4A-C, the detection mechanism 40 is isolated from the processing environment by use of a boundary, such as, a chamber wall 240, to prevent or reduce the interaction of the detection mechanism 40 with the processing environment. In another aspect, the detection mechanism 40 is mounted inside the processing environment but is positioned to minimize its affect on the processing area (e.g., processing compartment 150).

Referring to FIG. 2A, in one aspect of the invention, the angle of the incident/reflected radiation (see path “C”) that strikes and is reflected off of the surface of the substrate is substantially perpendicular (or normal) to the substrate surface to allow the reflection to follow the same path in which the emitted radiation was reflected. Therefore, in one aspect of the invention the angle of the emitted radiation from the detection mechanism 40 and the angle of the mirror 46 is aligned so that the angle of the emitted radiation reflected by the mirror is substantially normal to the substrate surface. In one embodiments, the mirror may reflect the emitted radiation, from the emission source 41A, at an angle that is not normal to the surface of the substrate but reflects the radiation at an angle such that the reflected radiation is collected by a separate detection system 55A (see FIG. 4D). This embodiment allows the mirror assembly 39 to placed in a position in the processing environment that will minimize any detrimental affects on the laminar flow over the surface of the substrate 10 and reduces its interaction with any corrosive vapors.

In one embodiment the broadband light source 41 will generally contain a housing 57, a light emission source 50 and an optical focusing means 52. In another embodiment the broadband light source 41 contains a light emission source 50 and a housing 57. The housing 57 encloses the light emission source 50 and allows the emitted light to pass through a single opening 57a to reduce the amount stray light that can affect the signal-to-noise ratio of the detector. The housing 57 also acts as black body to contain and emit the radiation generated from the light emission source 50. The optical focusing means 52 can be a lens or other device that collimates, focuses and/or directs the electromagnetic radiation emitted from the light emission source 50 towards a viewing area 68 on the surface of the substrate 10.

The light emission source 50 is a source of electromagnetic radiation that emits a broad spectrum of radiation across the range of wavelengths from about 200 nm to about 800 nm. Examples of possible electromagnetic radiation sources (broadband sources) might be a tungsten filament lamp, a laser (e.g., YAG, excimer, etc.), a laser diode, a xenon lamp, a mercury arc lamp, a metal halide lamp, a carbon arc lamp, a neon lamp, a sulfur lamp or a combination thereof. In one embodiment, one or more light-emitting diodes (LEDs) can be used as a electromagnetic radiation source. Light emitting diodes have some benefits over other designs since they can deliver an intense light at a very narrow range of wavelengths and they are relative inexpensive to replace if they become damaged. The use of one or more LEDs will also reduce the detection system complexity since it eliminates the need for a spectrometer, a monochromator, diffraction gratings, optical filters or other similar hardware. In one embodiment, an LED emitting a wavelength of about 670 nanometers (nm)+/−10 nanometers (nm) is used as the light emission source 50.

The mirror assembly 39 generally contains a mirror 46 and a mirror support 45. The mirror is designed reflect the electromagnetic radiation emitted from the broadband light source 41. In one aspect of the invention, the mirror 46 is a silver or an aluminum coated mirror, often called a broadband mirror, to reflect a wide range of wavelengths emitted from the broadband light source 41. Broadband mirrors can be purchased from CVI Laser, LLC of Albuquerque, N. Mex. In another aspect of the invention the mirror may selected to reflect only a narrow band of wavelengths, which are intended to be detected by the detection system 55. For example, if it is intended to measure the intensity of electromagnetic radiation at a wavelength of about 670 nm+/−10 nm, a ruby solid state mirror is used to reflect wavelengths in a range between about 640 nm to 780 nm. A ruby solid state mirror can be purchased from CVI Laser, LLC of Albuquerque, N. Mex. Mirrors that can only reflect a narrow band or wavelengths, or narrow band mirrors, can be used to improve the signal-to-noise ratio of the detection mechanism 40, since the number of unwanted wavelengths that are reflected by the mirror and collected by the detection system 55 will be greatly reduced.

Referring to FIG. 2A, the mirror support 45 is generally a structural support piece, made of a metal, coated metal, or other process compatible material, which is attached to a mounting surface (not shown) in the chamber 160 and is designed to support the mirror 46. In one embodiment, the mirror support 45 has a support hole 45a formed in it to allow wavelengths not reflected (see item “A”) by the mirror 46 to pass directly through the support hole 45a. The support hole 45a is important where certain wavelengths which are not intended to be reflected by the mirror 46 are reflected by the material from which the support 45 is made from. In one embodiment, the mirror support 45 is attached to an actuator (not shown) that is adapted to articulate the angle of the mirror relative to the surface of the substrate or change the position of the mirror over the surface of the substrate so that different areas of the substrate can be monitored.

The beam expander 42 is in general any optical system designed to increase the diameter of the radiation emitted by the light emission source 50. Generally, a beam expander is a telescope or other type of device that can produce a larger diameter collimated output beam, thus reducing the divergence of the emitted radiation (or beam). The beam expander thus allow an emitted beam of a certain size from the light emission source 50 to be expanded to a desired size so that the viewing area 68 of the projected radiation from the light source is a desired size to complete the monitoring process(es). The viewing area 68, or the area on the surface of the substrate on which the electromagnetic radiation emitted from the light emission source 50 is projected, is a process variable that can be adjusted to deliver the desired granularity to determine the state of the substrate surface. The variance in the signal received when using a smaller viewing area, may be larger than the variance seen when using a larger viewing area due to the reduced area to average the results over.

The beam splitter 44 is in general is an optical device, that splits a beam of light in two. The beam splitter thus transmits part of the radiation and reflects the other part. Usually, a beam splitter is a piece of glass with an optical coating, in which the optical coating determines the ratio between transmission and reflection of the an incident radiation. In its most common form, a beam splitter is a cube, made from two triangular glass prisms which are bonded together at their base using a resin or coating (see FIG. 2A item 44E). The thickness of the resin or coating layer can be adjusted such that (for a certain wavelength) some portion of the light incident through one “port” (i.e. face of the cube) is reflected and the remaining portion is transmitted. Therefore, by use of a beam splitter, the radiation can be divided and sent to two or more areas of the detection mechanism 40. Referring to FIG. 2A, the beam splitter 44 is used to allow the radiation emitted by the light emission source 50 and the subsequent radiation reflected off of the surface of the substrate 10 at the viewing area 68 to be transmitted along the same axis and also allow detection of the emitted signal. The use of the beam splitter thus eliminates the need to complete the labor intensive task of aligning the light emission source 50 and the detection system 55 at an optimum angle to allow the emitted beam from the broadband light source 41 to be collected by the detector system 55.

The source controller 141 controls the output intensity of the light emission source 50 and delivers an output signal to the main system controller 140. In one embodiment the source controller 141 is adapted to act as a monochromator that can deliver a single spectral line from the broadband (multi-wavelength) light emission source 50. In this embodiment the source controller 141 is designed such that it can sweep the range of emitted wavelengths from the broadband light emission source as a function of time via commands sent by the main system controller 140. The use of the source controller 141 as a monochromator allows various wavelengths to be scanned as a function of time to monitor and control the electroless process.

The detector system 55 includes an electromagnetic radiation detector 48, an optional optical focusing means 47, and a detector controller 142. In one embodiment, a housing (not shown), encloses and preferentially allows light emitted from the broadband light source 41 and reflected from the substrate 10 to be collected by the electromagnetic radiation detector 48. The electromagnetic radiation detector 48 is a detector configured to measure the intensity of electromagnetic radiation across one or more wavelengths. The electromagnetic radiation detector 48 may be selected from the following classes of sensors, for example, a photovoltaic, a photoconductive, a photoconductive-junction, a photoemissive diode, a photomultiplier tube, a thermopile, a bolometer, a pyroelectric sensor or other like detectors. In one embodiment a photoconductive detector, from Hamamatsu Photonics Norden AB, of Solna, Sweden or PLC Multipoint Inc. of Everett Wash., is used to detect a broad spectrum of the electromagnetic radiation. The optional optical focusing means 47 can be a lens or other device that collects, focuses and/or directs the electromagnetic radiation that passes through the through the beam splitter face 44B, as shown in FIG. 2A, to the electromagnetic radiation detector 48.

In one embodiment the detector system 55 is adapted to form a spectrometer (not shown). A spectrometer is used to collect the radiation from a broadband light source 41, split the radiation into discrete wavelengths, and detect the intensity of the radiation at each discrete wavelength. The spectrometer typically includes an input slit (not shown), a diffraction grating (not shown), a diffraction grating controller (not shown) and a detector array (not shown) to collect the incoming radiation. The diffraction grating controller allows the detector controller 142 to adjust the position of the diffraction grating to control the intensity of each wavelength detected by the discrete detectors (not shown) in the detector array. In one embodiment the spectrometer, is used to scan across a range of wavelengths of the emitted radiation as a function of time to monitor and control the electroless process.

In one embodiment of the present invention one or more optical filters (not shown) are added to the detector system 55, between the substrate surface and the electromagnetic radiation detector 48. The added optical filter(s) are selected to allow only certain desired wavelengths to pass to the electromagnetic radiation detector 48. This embodiment helps reduce the amount of energy striking the detector which can help improve the signal-to-noise ratio of the detected radiation. The optical filter(s) can be a bandpass filter, a narrowband filter, an optical edge filters, a notch filter, or a wideband filter purchased from, for example, Barr Associates, Inc. of Westford, Mass. or Andover Corporation of Salem, N.H. In another aspect of the invention an optical filter may be added to the broadband light source 41 to limit the wavelengths projected onto the substrate surface and detected by the detector system 55.

FIG. 2B illustrates another embodiment in which the emitted electromagnetic energy (or emitted beam) from the broadband light source 41 is aimed directly at the surface of the substrate 10 such that the mirror assembly 46 is not required to direct the electromagnetic radiation to the surface of the substrate 10 and return the reflected electromagnetic radiation to the detection system 55. This embodiment may be useful to reduce the cost, complexity and setup time of the detection mechanism 40, since a mirror assembly 39 wouldn't need to be aligned relative to the surface of the substrate and the detection mechanism 40. In one aspect of the invention, the angle of the incident/reflected radiation (path “C”) that strikes and is reflected off of the surface of the substrate is substantially perpendicular to the substrate surface to allow the reflection to follow the same path in which the emitted beam was reflected. In another aspect of the invention, the substantially perpendicular angle of the emitted beam on the surface of the substrate is used to prevent the shape of the emitted beam projected on the surface of the substrate, or the viewing area 68, from being distorted due to the non-normal angle of incidence. For example, if the emitted beam from the detection mechanism 40 is circular in shape the viewing area 68 will have an elliptical shape when it is projected at an angle other than normal to the surface of the substrate. The shape of the viewing areas 68 can have an effect on the signal-to-noise ratio of the detected signal when used on surfaces that have a varying feature surface 26a density.

FIG. 2C illustrates one embodiment of the detection mechanism 40 adapted for use in a face-down substrate processing system. In this embodiment, the detection mechanism 40 contains a broadband light source 41, a detector system 55 and a fiber optic cable 78 mounted to the bowl 176. The fiber optic cable 78 is mounted into an area of the bowl 176 that allows it to view the center of rotation of the substrate 10 when it is in the process position (shown in FIG. 2A). The detection mechanism 40 is remoted from the bowl and is adapted to deliver the electromagnetic radiation to one end of the fiber optic cable 78. An o-ring seal 185 is used to form a seal between the fiber optic cable 78 and the bowl 176 to prevent fluid leakage from the bowl 176. During processing the one end of the fiber optic cable 78 is immersed in the process fluids, delivered to the chamber via the fluid sources 128a-f. In this configuration the projected radiation from the broadband light source 41 passes through the beam splitter 44, passes through the fiber optic cable 78, through the process fluid, is reflected off the surface of the substrate, passes back through the process fluid, then through the fiber optic cable 78, then back into the beam splitter 44 where the reflected radiation is reflected by the beam splitter 44 to the detector system 55.

Referring to FIGS. 2A, 2B and 2C, the controller 140 is generally designed to facilitate the control and automation of the overall system and typically may includes a central processing unit (CPU) 146, memory 144, and support circuits (or I/O) 148. The CPU 146 may be one of any form of computer processors that are used in industrial settings for controlling various chamber processes and hardware (e.g., detectors, motors, fluid delivery hardware, etc.) and monitor the system and chamber processes (e.g., chamber temperature, process time, detector signal, etc.). The memory 144 is connected to the CPU 146, and may be one or more of a readily available memory, such as random access memory (RAM), read only memory (ROM), floppy disk, hard disk, or any other form of digital storage, local or remote. Software instructions and data can be coded and stored within the memory 144 for instructing the CPU 146. The support circuits 148 are also connected to the CPU 146 for supporting the processor in a conventional manner. The support circuits 148 may include cache, power supplies, clock circuits, input/output circuitry, subsystems, and the like. A program (or computer instructions) readable by the controller 140 determines which tasks are performable on a substrate. Preferably, the program is software readable by the controller 140, that includes code to generate and store at least substrate positional information, spectrum from a detector 48, intensity and wavelength information versus substrate position information, intensity and wavelength data as a function of time, calibration information and any combination thereof.

The controller 140 can be configured to compare the intensity of the detected radiation at one or more wavelengths to determine the state of the electroless deposition process step and according to programmed instructions will modify the electroless deposition process step as required. The term electroless deposition process step is generally meant to encompass the various steps or phases of the electroless deposition process which may include, for example, a catalytic layer deposition process, a conductive cap layer deposition process, a pre-rinse step, a rinse step, a post-cap layer or a cleaning process steps. The term modify the electroless deposition process step is meant to generally describe an action that the controller 140 takes to assure that the electroless deposition process step is performed as desired (e.g., monitor and/or control the electroless process). Typical actions which the controller 140 may complete to modify an electroless deposition process step may include, for example, rinsing the substrate surface, continue to monitor the detected intensity, drying the surface of the substrate, starting a process timer, ending the electroless deposition process step, warning the user, storing the intensity at one or more wavelengths and other process data in a memory location in the controller, or waiting until a monitored electroless deposition process variable reaches some user defined process value and then taking some action. As noted above by use of a monochromator or spectrometer, intensity results at a particular wavelength on a particular area on the surface of the substrate at particular instant in time can be singled out and compared with intensity results measured in the same area on the surface of the substrate at the same wavelength at a second instant in time. The selection of which wavelengths should be monitored to detect the initiation of the electroless deposition process, the end of a processing step or electroless deposition process endpoint is dependent on the electroless process type (e.g., catalytic layer deposition, cap layer deposition, etc.), the thickness of the deposited film, and/or the type of materials present on the substrate 10 (e.g., dielectric layer material, dielectric layer thickness, barrier material, conductive layer material, seed layer material, etc.).

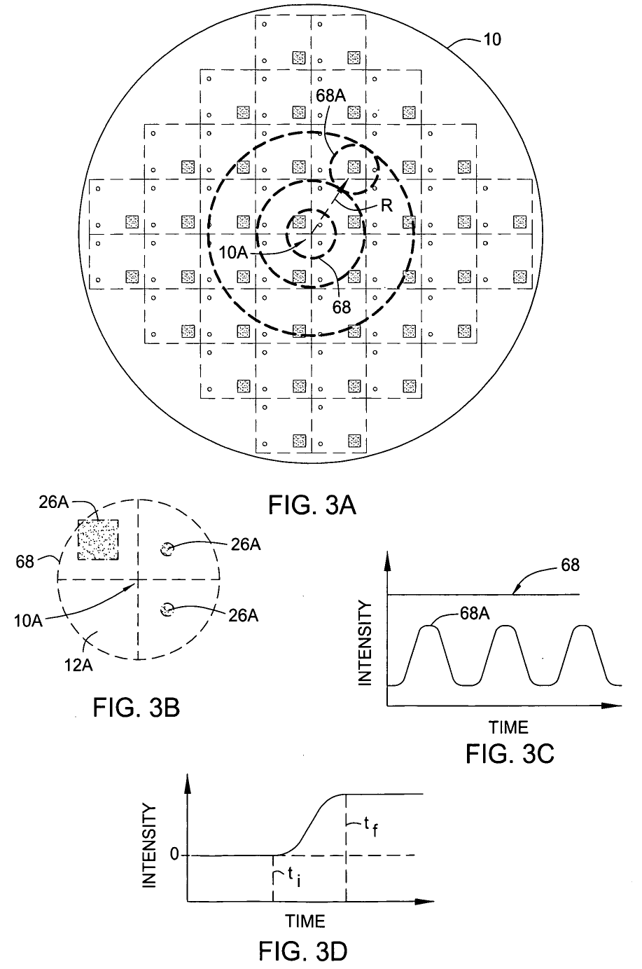

In one embodiment the controller 140 is used to monitor the rate of change of intensity of the reflected radiation from the surface of the substrate as a function of time. Using this method the controller can detect the transition of the electroless deposition process into different phases, such as the beginning (e.g., initiation) and the end of the process, by an increase or decrease in the rate of change of the intensity of the reflected radiation at one or more wavelengths. FIG. 3D illustrates a typical plot of the intensity signal measured from the detector system 55 as a function of time for a single wavelength of radiation or an average over multiple wavelengths. The intensity's rate of change can be found by calculating the slope of the intensity versus time plot at any instant of time. The rate of change in intensity at one or more wavelengths can be directly related to the electroless deposition rate, even though the relationship of the rate of change of the measured intensity and the deposition rate may not be constant throughout the process. The relationship of the rate of change in intensity and the deposition rate may depend, for example, on the type of materials deposited (e.g., cap layer materials (Cobalt, Cobalt-tungsten-phosphorus, etc.), catalytic layer materials, etc.), a change in roughness of the surface, contamination on the feature surface 26a, or the concentration of certain constituents in the fluid. Since the measurement of the intensity relates to an optical property of the surface of the substrate and not necessarily to the thickness of the deposited film, as compared to other process monitoring techniques (e.g., resistance measurement, eddy current, metapulse techniques, etc.), process characterization steps for different electroless deposition processes are required to correlate the measured intensity signal and the actual state of the deposition process. In a further aspect of the invention, the acceleration or deceleration of the intensity signal (e.g., change in deposition rate), or the rate of change of the rate of change of the intensity signal as a function of time, may be used as an advantage to sense the speeding-up or slowing down of the deposition process to signify a transition to a certain phase (e.g., initiation, etc.) of the deposition process.

Patterned Substrate Monitoring

FIG. 3A illustrates a top view of the surface of a substrate 10 that has patterned features formed into the substrate surface. FIG. 3A also illustrates possible positions of the viewing area 68 on the substrate surface. As noted above the size of the viewing area 68 can be a process variable that can be adjusted to deliver the desired granularity to determine the state of the substrate surface.

The detection of reflected radiation can become complicated in cases where the surface of the substrate contains an array of exposed features that varies in density (i.e., surface area) across the substrate surface, since a varying density will cause the intensity of the reflected radiation, exposed to the emitted radiation at the viewing area 68, to vary. In other words the surface area of the exposed features directly affects the intensity of the detection signal reflected off of the surface of the substrate at the viewing area 68. This problem is further increased for deposition processes that require the substrate to be rotated while the process is being monitored by the detection system 40. The rotational issue arises where the viewing area 68A is positioned a distance “R” from the center of rotation 10A of the substrate (see FIG. 3A). In this case the signal will vary as the viewing area 68 is exposed to the varying density of the feature surfaces 26a. In one aspect of the invention, the viewing area 68 is aligned with the center of rotation of the substrate during processing, since the density of the feature surfaces 26a seen by the viewing area does not vary as the substrate is rotated. FIG. 3B illustrates a close up view of a centrally located viewing area to illustrates that while the angular position of the substrate feature surfaces 26a will vary as the substrate is rotated, the density of the features will not vary as a function of time, since the feature surfaces 26a do not move from the viewing area 68.

In one aspect of the invention, the shape of the viewing area 68 is substantially circular in shape. Referring to FIGS. 2A-C, in one embodiment, an anamorphic prism (not shown) is placed between the light emission source 50 and the beam expander 42 and is used to correct an asymmetric radiation pattern from the light emission source 50, such as a radiation pattern from a diode laser. An anamorphic prism is meant to correct inherent asymmetric radiation pattern and elliptical beam shape due to the process emitting electromagnetic radiation from a diode junction. The anamorphic prism pair corrects the asymmetry, from elliptical to near circular shape, by expanding the beam in only one direction while the other direction remains unchanged. Anamorphic prisms can be purchased from CVI Laser, LLC of Albuquerque, N. Mex. In one aspect of the invention, the viewing area may be as small as about 2 to about 50 micrometers (μm) in diameter. In another aspect of the invention, the viewing area may be as large as the complete surface area of the substrate. In another aspect of the invention, the preferred viewing area diameter is about 1 to about 25 millimeters (mm), and more preferably between about 5 to about 15 mm. In another aspect of the invention the viewing area 68 is elliptical, rectangular, star shape or other equivalent shape that may be useful to monitor the chamber process(es). Preferably, the viewing area 68 is substantially circular in shape and is placed at the center of rotation of the substrate, since and feature surfaces 26a that are inside or outside the viewing area 68 will not enter and exit the viewing area 68 and thus the surface area of the feature surfaces 26a within the viewing area 68 will remain constant and the signal-to-noise ratio will be improved.

FIG. 3C is a schematic representation of a plot of signal intensity versus time as a substrate having a varying density of feature surfaces 26a is rotated. FIG. 3C illustrates the difference is the detected signal received from radiation reflected from a viewing area 68, which is positioned at the center of rotation 10A of the substrate, and a viewing area 68A, which is positioned a distance from the center of rotation 10A.

In some cases it may be useful to move the viewing area 68A across the substrate to monitor the state of the deposition process at different at areas on the substrate surface. To resolve the intensity variation as a function of time, in one aspect of the invention, the controller 140 is used to sum the measured intensity over a period of time and then divide the summed intensity by the measurement period to find an average intensity. In another aspect of the invention, the surface of the substrate can be compared at one instant of time versus another instant of time by monitoring the angular position of the substrate by use of an encoder (not shown) attached to the motor 114, and thus comparing the intensity results measured at the same angular position every time it passes the detection mechanism. In another aspect of the invention, a noise minimization/detection software is used to damp the variation in intensity.

In another embodiment of the present invention, the wavelength of the projected radiation projected through the deposition fluid does not affect the deposition process (e.g., photosensitive components in fluid, etc.). In the same way it is generally preferred that the emitted wavelengths are not absorbed by components in the fluid and thus affect the signal-to-noise ratio of the detected signal.

In another aspect of the invention, the projected electromagnetic radiation contains wavelengths that are absorbed by components in the deposition fluid. In this embodiment some of the absorbed wavelengths can be used to detect changes in concentration of the electroless deposition fluid components by an increase or decrease in the intensity of the detected radiation. In another embodiment of the present invention a comparison is made between wavelengths that interact (e.g., absorbed, reflected, etc.) with the components in the deposition fluid that are being deposited and also wavelengths that are reflected off the feature surface 26a. In this embodiment the change in the intensity of the wavelength(s) associated with the deposition fluid are intended to monitor the change in concentration of the components that are being deposited. This technique utilizes the system to monitor the growth of the electroless film by use of two process variables in which one is not affected by changes in optical properties of the substrate surface, and when used together can help verify the results obtained from each technique.

As noted above, surface contamination or oxidation has an effect on the time it takes the electroless deposition process to initiate or begin to deposit material. Once the electroless reaction has initiated, the time to deposit a defined amount of material is predictable and will generally fall into a relatively repeatable range of times. Therefore in one embodiment the detection mechanism 40 is used to sense the “initiation” of the electroless deposition process so that the controller can start a timer that will allow the process to run until a defined period of time has lapsed, and thus the end of the process is reached. The amount of time the timer counts before the process is stopped is dependent on the process conditions (e.g., process temperature, concentration of the deposition components, state of the feature surface 26a prior to deposition, fluid agitation, etc.) and the thickness of the deposited material, and is preferably user defined. The magnitude of the user defined process time can be created from data collected from other substrates that are run using similar process conditions and deposition thicknesses. In this mode, after the detection mechanism has sensed the initiation of the reaction, the detection mechanism may or may not monitor the rest of the deposition process. This embodiment can be important for processes where the signal is weak at the end of the process or the signal-to-noise ratio increases towards the end of the process.

In one embodiment the detection mechanism 40 is used to sense the start of the initiation process, a timer is then started, and then by use of the controller 140, the fluid source 128, and the nozzle 123 the substrate 10's surface is rinsed after the defined period of time has lapsed. This embodiment is important in cases where the feature surfaces 26a or the conductive material layer 26 surfaces corrode due to an extended exposure to the deposition fluid. The corrosion of the feature surfaces 26a or the conductive material layer 26 surfaces can affect the electrical properties of the subsequently formed semiconductor device.

One issue that can arise is when the dielectric thickness is rather small and/or the wavelength of electromagnetic radiation is transmitted rather than absorbed by the dielectric material (dielectric material is generally transparent>300 nm) some reflections collected by the detector system 55 may occur from reflective layers below the surface of the substrate. Reflections from surfaces that are not on the top surface may be avoided by careful selection of the emitted and detected wavelengths that are not transmitted through the dielectric layers and by use of signal normalization techniques.

Chamber Hardware

FIGS. 2A and 2B illustrate a schematic cross-sectional view of one embodiment of a chamber 160 useful for the deposition of a catalytic layer and/or a conductive material layer as described herein. Of course, the chamber 160 may also be configured to deposit other types of layers other than the catalytic layer and the conductive material layer. The apparatus to electroless deposit the catalytic layer and metallic layers described in the U.S. patent application Ser. No. 10/059,572 [AMAT 5840.03], entitled “Electroless Deposition Apparatus” filed on Jan. 1, 2002 is incorporated by reference herein to the extent not inconsistent with the claimed aspects and disclosure herein. Chamber 160 includes a processing compartment 150 comprising a top 152, sidewalls 154, and a bottom 156. A substrate support 162 is disposed in a generally central location in the chamber 160, and includes a substrate receiving surface 164 adapted to receive a substrate 10 in a face-up position. The chamber 160 further includes a clamp ring 166 configured to hold the substrate 10 against the substrate receiving surface 164. In one aspect, the clamp ring 166 improves the heat transfer between substrate 10 and the heated substrate support 162. Typically the substrate support 162 may heated by use of an external power source and one or more resistive elements embedded in the substrate support 162. In another aspect, the clamp ring 166 holds the substrate during rotation of the substrate support 162. In still another aspect, the thickness of the clamp ring 166 is used to form a pool of deposition fluid 168 on the surface of the substrate 10 during processing.

The chamber 160 further includes a slot 108 or opening formed through a wall thereof to provide access for a robot (not shown) to deliver and retrieve the substrate 10 to and from the chamber 160. Alternatively, the substrate support 162 may raise the substrate 10 through the top 152 of the processing compartment to provide access to and from the chamber 160. The chamber 160 further includes a drain 127 in order to collect and expel fluids used in the chamber 160.

A lift assembly 116 may be disposed below the substrate support 162 and coupled to lift pins 118 to raise and lower lift pins 118 through apertures 120 in the substrate support 162. The lift pins 118 raise and lower the substrate 10 to and from the substrate receiving surface 164 of the substrate support 162. The lift assembly may also be adapted to detach and engage the clamp ring 166 to the surface of substrate 10 to allow the substrate to be clamped to the surface of the substrate support 162 in one case and in another case to allow the substrate 10 to be transferred from the chamber 160.

A motor 114 may be coupled to the substrate support 162 to rotate the substrate support 162 to spin the substrate 10. In one embodiment, the lift pins 118 may be disposed in a lower position below the substrate support 162 to allow the substrate support 162 to rotate independently of the lift pins 118. In another embodiment, the lift pins 118 may rotate with the substrate support 162.

The substrate support 162 may be heated to heat the substrate 10 to a desired temperature. The substrate receiving surface 164 of the substrate support 162 may be sized to substantially receive the backside of the substrate 10 to provide uniform heating of the substrate 10. Uniform heating of a substrate is an important factor in order to produce consistent processing of substrates, especially for deposition processes having deposition rates that are a function of temperature.

A fluid input, such as a nozzle 123, may be disposed in the chamber 160 to deliver a fluid, such as a chemical processing solution, deionized water, and/or an acid solution, to the surface of the substrate 10. The nozzle 123 may be disposed over the center of the substrate 10 to deliver a fluid to the center of the substrate 10 or may be disposed in any position. The dispense arm 122 may be moveable about a rotatable support member 121 which is adapted to pivot and swivel the dispense arm 122 and the nozzle 123 to and from the center of the substrate 10. The dispensed fluid may be collected by the drain 149.

A single or a plurality of fluid sources 128a-f (collectively referred to as “fluid sources”) may be coupled to the nozzle 123. Valves 129 may be coupled between the fluid sources 128 and the nozzle 123 to provide a plurality of different types of fluids. Fluid sources 128 may provide, for example and depending on the particular process, deionized water, acid or base solutions, salt solutions, catalytic layer solutions (e.g., noble metal/Group IV metal solutions (i.e. palladium and tin solutions), semi-noble metal/Group IV metal solutions (i.e. cobalt and tin solutions), noble metal solutions, semi-noble metal solutions, Group IV metal solutions), conductive cap layer solutions (e.g., Cobalt (Co), Cobalt-tungsten-phosphorus (CoWP), etc.), reducing agent solutions, and combinations thereof. Preferably, the chemical processing solutions are mixed on an as-needed basis for each substrate 10 that is processed.

The valves 129 may also be adapted to allow a metered amount of fluid to be dispensed to the substrate 10 to minimize chemical waste since some of the chemical processing solutions may be very expensive to purchase and to dispose of.

In an embodiment, where the substrate support 162 is adapted to rotate the rotational speed of the substrate support 162 may be varied according to a particular process being performed (e.g. deposition, rinsing, drying.) In the case of deposition, the substrate support 162 may be adapted to rotate at relatively slow speeds, such as between about 10 RPMs and about 500 RPMs, depending on the viscosity of the fluid, to spread the fluid across the surface of the substrate 10 by virtue of the fluid inertia. In the case of rinsing, the substrate support 162 may be adapted to spin at relatively medium speeds, such as between about 100 RPMs and about 500 RPMs. In the case of drying, the substrate support may be adapted to spin at relatively fast speeds, such as between about 500 RPMS and about 2000 RPMs to spin dry the substrate 10. In one embodiment, the dispense arm 122 is adapted to move during dispensation of the fluid to improve fluid coverage of the substrate 10. Preferably, the substrate support 162 rotates during dispensation of a fluid from the nozzle 123 in order to increase throughput of the system.

The substrate support 162 may include a vacuum port 124 coupled to a vacuum source 125 to supply a vacuum to the backside of the substrate to vacuum chuck the substrate 10 to the substrate support 162. Vacuum Grooves 126 may be formed on the substrate support 162 in communication with the vacuum port 124 to provide a more uniform vacuum pressure across the backside of the substrate 10. In one aspect, the vacuum chuck improves heat transfer between the substrate 10 and the substrate support 162. In addition, the vacuum chuck holds the substrate 10 during rotation of the substrate support 162.

The substrate support 162 may comprise a ceramic material (such as alumina Al₂O₃ or silicon carbide (SiC)), TEFLON™ coated metal (such as aluminum or stainless steal), a polymer material, or other suitable materials. The substrate support 162 may further comprise embedded heated elements, especially for a substrate support comprising a ceramic material or a polymer material.

Face-Down Hardware

FIG. 2C illustrates a schematic cross-sectional view of another embodiment of a chamber 170 useful for the deposition of a catalytic layer and/or a conductive material layer. The chamber 170 includes a substrate holder 172 having a substrate receiving surface 174 adapted to hold a substrate 10 in a face-down position. The substrate holder 172 may be heated to heat the substrate 10 to a desired temperature. The substrate receiving surface 174 of the substrate holder 172 may be sized to substantially receive the backside of the substrate 10 to provide uniform heating of the substrate 10. The substrate holder 172 further includes a vacuum port 173 coupled to a vacuum source 183 to supply a vacuum to the backside of the substrate 10 to vacuum chuck the substrate 10 to the substrate holder 172. The substrate holder 172 may further include a vacuum seal 181 and a liquid seal 182 to prevent the flow of fluid against the backside of the substrate 10 and into the vacuum port 173. The chamber 170 further comprises a bowl 176 having a fluid input, such as a fluid port 177. The fluid port 177 may be coupled to a fluid source 128a-c, a fluid return 179, and/or a gas source 180. In one embodiment a fluid waste drain 184 can be adapted to collect the fluids used during processing.

The substrate holder 172 may further be coupled to a substrate holder assembly 171 adapted to raise and lower the substrate holder 172. In one embodiment, the substrate holder assembly may be adapted to immerse the substrate 10 into a puddle or a bath. In another embodiment, the substrate assembly may be adapted to provide a gap between the substrate 10 and the bowl 176. The fluid source 128 is adapted to provide a fluid through the fluid port 177 to fill the gap between the substrate 10 and the bowl 176 with a fluid layer (see item “D” showing the fluid flow path). In one embodiment a fluid is sprayed onto the surface of the substrate 10 by use of spray or atomizing nozzles (not shown) mounted on the bowl 176 and connected to the fluid source 128a-c. The substrate assembly may be adapted to rotate the substrate holder 172 to provide agitation of the fluid layer.

The bowl 176 may further comprise a heater to heat the fluid layer to a desired temperature. After processing with the fluid layer is complete, the fluid return 179 is adapted to pull the fluid back through a drain or the fluid port 177 in order to reclaim the fluid for reuse it in processing other substrates. The gas source 180 is adapted to provide a gas, such as nitrogen, to the surface of the substrate 10 to facilitate drying of the substrate 10. The substrate holder assembly may be further adapted to rotate the substrate holder 172 to spin dry the substrate 10. The chamber 170 may further include a retractable hoop 175 adapted to hold the substrate 10 for transfer from and to the chamber 170. For example, the retractable hoop may include two partial-rings (i.e. each shaped as a “C”). The rings may be moved together to receive a substrate 10. The rings may be move apart to allow the substrate holder 172 to be lowered proximate the bowl 176.

The chambers of FIGS. 2A-C may be adapted for the processing of 200 mm substrates, 300 mm substrates, or any sized substrates. The chambers have been shown for single-substrate processing. However, the chambers may be adapted for batch processing. The chambers may be adapted for single use of fluid or may be adapted to recirculate fluids which are reused for a number of substrates and then dumped. For example, in one embodiment, a chamber adapted to recirculate fluids comprises a drain which selectively diverts certain fluids to be reused during processing. If the chamber is adapted to recirculate fluids, the fluid lines should be rinsed in order to prevent deposition in and clogging of the lines. Although the embodiments of the chambers have been described with certain elements and features, it is understood that a chamber may have a combination of elements and features from the different embodiments.

Chamber Integration

FIGS. 4A-D are cross sectional views that illustrate various embodiments of an electroless processing chamber 320 in which the detection mechanism 40 is separated from the processing region 207 so that the detection mechanism 40 will not degrade the processing characteristics of the chamber (e.g., particle performance, etc.) and it will not be affected by splashing of the fluids dispensed during processing or attacked by the corrosive vapors found in the processing region 207. The electroless processing chamber 320, which is mounted on a mainframe 200, may generally include a HEPA filter assembly 220, a plurality of outer walls 240 to enclose the processing region 207, a bowl assembly 217, and substrate support assembly 250. Examples of an exemplary mainframe and processing chamber designs are further described in the U.S. patent application Ser. No. 10/965,220 entitled “Apparatus For Electroless Deposition” filed Oct. 14, 2004 (APPM 8707.02) and U.S. patent application Ser. No. 10/996,342 entitled “Apparatus For Electroless Deposition Of Metals On Semiconductor Wafers” filed Nov. 22, 2004 (APPM 9032), which are incorporated by reference herein to the extent not inconsistent with the claimed aspects and disclosure herein.

The HEPA filter assembly 220 generally contains a filter 221, an inlet 223 and an outer enclosure 222. During processing an inert gas (e.g., nitrogen, argon, etc.), or air, flows into a plenum 224, formed between the outer enclosure 222 and the filter 221, from gas source (not shown). The inert gas or air in the plenum 224 then flows through the filter 221 and down towards the surface of the substrate 10 which is resting on the substrate supporting surface 251. The filter 221 is designed to remove particles from the inert gas, or air, and/or to minimize gas turbulence in the processing region 207. Inert gas or air turbulence can stir-up or dislodge particles attached to surfaces in the processing region 207, which may cause particles to land on the surface of the substrate 10. To minimize number of particle sources, which can contaminate the surface of the substrate 10, it is often desirable to minimize the number of obstructions and/or the surface area of components that are within the processing region.

The substrate support assembly 250 is configured to support a substrate 10 for processing in the respective station in a face up orientation, i.e., the processing surface of the substrate is facing away from the substrate supporting surface 251. The substrate support assembly 250 generally contains a backside heater assembly 260, a rotation motor 212, and a lift pin assembly 252. The backside heater assembly 260 contains an upper platen 203 that forms a substantially horizontal upper surface configured to receive a substrate for processing. The platen 203, which may be manufactured from a ceramic or metal material, also includes at least one fluid aperture 213 formed therethrough, and the fluid aperture 213 is generally in fluid communication with a fluid supply conduit 209. Supply conduit 209 is generally in fluid communication with at least one fluid source 208, which may be a cleaning fluid, a rinsing fluid, a processing fluid, etc. The substrate support assembly 250 further includes a lift pin assembly 252 that is independently movable with respect to the backside heater assembly 260. The lift pin assembly 252 includes a plurality of evenly spaced substrate supporting surfaces 251 that are configured to engage and secure a substrate during processing in a conventional manner. The lift pin assembly 252 is configured to be both rotatable with respect to backside heater assembly 260, via use of the rotation motor 212, and vertically actuatable with respect to backside heater assembly 260, via use of a lift mechanism (not shown). The backside heater assembly 260 typically will remain stationary and is supported by the support 214. Additionally, the substrate supporting surfaces 251 may include an upstanding wall portion having inwardly projecting lip configured to engage and support a substrate thereon between the wall portions.

The bowl assembly 217 generally contains walls 216, a base 215 and a drain/exhaust port 210 which enclose the bottom portion of the process chamber 320. The bowl assembly 217 will collect the processing fluid delivered to the surface of the substrate 10 and the inert gas or air injected into the processing region 207 by the HEPA filter assembly 220. The processing fluid(s) are delivered to the substrate 10 from the fluid nozzle 123 which is connected to the fluid sources 128a-f. The collected fluid is then drained through the drain/exhaust port 210 to a waste treatment system (not shown). The inert gas or air is removed from the processing region 207 by use of an exhaust pump (not shown) attached to the drain/exhaust port 210.

During processing, the substrate 10 is secured by substrate supporting surfaces 251, and the substrate 10 is positioned just above the backside heater assembly 260. The space between the backside heater assembly 260 and substrate 10 is filled with a temperature controlled fluid dispensed from conduit 209. The fluid contacts the substrate and transfers heat thereto to heat the substrate 10. In this embodiment, the substrate is generally positioned between about 0.2 mm and about 10 mm away from the backside heater assembly 260. The temperature controlled fluid is heated by use of a heater 206 attached to a fluid source 208 and/or heater element embedded in the backside heater assembly 260.

FIG. 4A illustrates one embodiment where through use of a mirror assembly 39, which is mounted in the processing region 207, a detection mechanism 40 that is mounted to a chamber wall 240 is able to monitor the state of a process being performed on the surface of a substrate 10. This embodiment thus allows the detection mechanism 40 to be isolated from the process region 207. In one aspect of the invention the chamber wall 240 is optically transparent to the radiation emitted from the detection mechanism 40. In one aspect of the invention an optically transparent region, or window 222, (shown in FIG. 4A) is attached to the wall to allow the radiation emitted from the detection mechanism 40 to enter the processing region 207 and the reflected radiation to return to the detection mechanism 40. In one aspect of the invention, as shown in FIG. 4A, the mirror support 45 of the mirror assembly 39 is attached to the HEPA filter assembly 220.

FIG. 4B illustrates an embodiment is which the detection mechanism 40 is mounted above the surface of the substrate 10 to monitor the state of a process being performed on the surface of a substrate 10. The detection mechanism 40 may be mounted outside of the processing region 207, or as shown in FIG. 4B, to the HEPA filter assembly 220. In this configuration the detection mechanism 40 is isolated from the process volume 207 by use of a window 222 which is sealed to the HEPA filter assembly 220, and allows the emitted radiation from the detection mechanism 40 to be transmitted through the window 222 towards the substrate and the reflected radiation to return to the detection mechanism 40.

FIG. 4C illustrates one embodiment, in which the detection mechanism 40 is remoted from the processing chamber 320 and adapted to view the surface of the substrate 10 by use of a fiber optic cable 225. In this configuration one end of the fiber optic cable is in communication with the detection mechanism 40 and the other end is mounted to the top of the processing chamber (e.g., the HEPA filter assembly 220). In one aspect of the invention the detection mechanism 40 emits radiation that is collected and transmitted through the fiber optic cable 225 and the transparent window 222 and into the processing region 207. The emitted radiation then passes through the process fluid on the substrate surface, is reflected off of the surface features 26a, passes back through the process fluid, then travels through the window 222 and fiber optic cable 225 to the detection mechanism 40 where the signal can be detected. In another aspect of the invention the window 222 is not placed between the end of the fiber optic cable 225 and the surface features 26a.

FIG. 4D illustrates one embodiment where through use of a mirror assembly 39, which is mounted in the processing region 207, an emission source 41A and a detection system 55A are able to monitor the state of a process being performed on the surface of a substrate 10. In this embodiment the mirror assembly 39 is placed in a position in the processing region 207 so that any detrimental affects caused by having the mirror assembly 39 mounted in the processing region is minimized. In one aspect of the invention, the mirror is oriented to reflect the emitted radiation, from the emission source 41A, at an angle that is not normal to the surface of the substrate but reflects the radiation at an angle such that the reflected radiation is collected by a separate detection system 55A. This embodiment thus allows the detection mechanism 40 to be isolated from the process region 207 and also minimizes the affect of having unwanted surfaces in the processing region. In one aspect of the invention the chamber wall 240 is optically transparent to the radiation emitted from the emission source 41A. In one aspect of the invention an optically transparent region, or window 222, (shown in FIG. 4A) is attached to the wall to allow the radiation emitted from the emission source 41A to enter the processing region 207, be reflected by the mirror assembly 39, then reflected from the surface of the substrate 10 and received by a detection system 55A which may be attached to a wall 240. In one aspect of the invention, as shown in FIG. 4D, the mirror support 45 of the mirror assembly 39 is attached to a wall 240.

In one embodiment one or more anamorphic prisms (see Item 275) are added between the emission source 41A and a detection system 55A to correct for the distortion of the viewing area 68 shape caused by the non-normal angle of incidence of the emitted radiation on the surface of the substrate. This embodiment can thus allow the mirror assembly 39 to be positioned to minimize the negative effects of having it in the processing region, while allowing the projected radiation at the viewing area 68 to be substantially circular in shape, and projected at the center of rotation if needed, to improve the signal-to-noise ratio of the detection system 40.

In one embodiment, the mirror assembly 39, shown in FIGS. 4A-D, is attached to an actuator (not shown) that is adapted to articulate the angle of the mirror relative to the surface of the substrate or change the position of the mirror over the surface of the substrate so that different areas of the substrate can be monitored.

While the foregoing is directed to embodiments of the present invention, other and further embodiments of the invention may be devised without departing from the basic scope thereof, and the scope thereof is determined by the claims that follow.

1. An apparatus for monitoring an electroless deposition process comprising:
a plurality of chamber walls that enclose a processing region;
a substrate support disposed in the processing region having a substrate receiving surface;
an electromagnetic radiation source that is mounted proximate to the processing region and is adapted to emit electromagnetic radiation that strikes a surface of a substrate mounted on the substrate receiving surface at an angle that is substantially perpendicular to the substrate surface;
a detector that is mounted proximate to the processing region and is adapted to detect the intensity of reflected electromagnetic radiation from the surface of the substrate during an electroless deposition process; and
a controller adapted to receive a signal from the detector and modify the electroless deposition process.

2. The apparatus of claim 1, wherein the electromagnetic radiation source emits electromagnetic radiation at wavelengths between about 200 nanometers and about 800 nanometers.

3. The apparatus of claim 1, wherein the electromagnetic radiation source emits electromagnetic radiation at a wavelength between about 660 nanometers and about 680 nanometers.

4. The apparatus of claim 1, further comprising a drive mechanism to rotate the substrate support relative to the detector, wherein the substrate support has a center of rotation.

5. The apparatus of claim 4, wherein the electromagnetic radiation that strikes a surface of a substrate, positioned on the substrate support, is substantially circular in shape and is positioned at the center of rotation of the substrate support.

6. The apparatus of claim 5, wherein the diameter of the substantially circular electromagnetic radiation is between about 2 micrometers and about 25 millimeters.

7. The apparatus of claim 5, wherein the diameter of the substantially circular electromagnetic radiation is between about 1 millimeter and about 20 millimeters.

8. The apparatus of claim 1, wherein the detector is a spectrometer.

9. The apparatus of claim 1, further comprising a fiber optic cable which receives the electromagnetic radiation from the electromagnetic radiation source and directs it towards the substrate receiving surface.

10. The apparatus of claim 1, wherein the controller further comprises
a memory attached to the controller to store the signal data; and
a control device wherein the controller device is used to control the electroless deposition process based on commands from the controller based on the comparison of the signal data and a process value.

11. An apparatus for monitoring an electroless deposition process comprising:
a plurality of chamber walls that enclose a processing region;
a substrate support disposed in the processing region having a substrate receiving surface;
a mirror mounted in the processing region;
an electromagnetic radiation source that is mounted proximate to the processing region and is adapted to emit electromagnetic radiation that strikes the mirror and the mirror reflects the electromagnetic radiation towards a surface of a substrate mounted on the substrate receiving surface;
a detector that that is mounted proximate to the processing region and is adapted to detect the intensity of reflected electromagnetic radiation from the surface of the substrate during an electroless deposition process; and
a controller adapted to receive a signal from the detector and modify the electroless deposition process.

12. The apparatus of claim 11, wherein the mirror is a broadband mirror or a narrow band mirror.

13. The apparatus of claim 12, wherein the narrow band mirror reflects wavelengths between about 640 nanometers and about 780 nanometers.

14. The apparatus of claim 11, wherein the detector is a spectrometer.

15. The apparatus of claim 11, wherein the electromagnetic radiation source emits electromagnetic radiation at wavelengths between about 200 nanometers and about 800 nanometers.

16. The apparatus of claim 11, further comprising a drive mechanism to can rotate the substrate support relative to the detector, wherein the substrate support has a center of rotation.

17. The apparatus of claim 16, wherein the electromagnetic radiation that strikes a surface of a substrate, which is positioned on the substrate support, is substantially circular in shape and is positioned at the center of rotation of the substrate support.

18. The apparatus of claim 17, wherein the diameter of the substantially circular electromagnetic radiation is between about 2 micrometers and about 25 millimeters.

19. The apparatus of claim 17, wherein the diameter of the substantially circular electromagnetic radiation is between about 1 millimeter and about 20 millimeters.

20. The apparatus of claim 11, wherein the electromagnetic radiation source is one or more light emitting diodes.

21. An apparatus for monitoring an electroless deposition process comprising:
a plurality of chamber walls that enclose a processing region;
a substrate support disposed in the processing region having a substrate receiving surface;
a drive mechanism that can rotate the substrate support;
an electromagnetic radiation source that is mounted proximate to the processing region and is adapted to emit electromagnetic radiation at a wavelength between about 660 nanometers and about 680 nanometers that is in communication with a center of rotation on a surface of a substrate mounted on the substrate receiving surface at an angle that is substantially perpendicular to the substrate receiving surface;
a detector that that is mounted proximate to the processing region and is adapted to detect the intensity of reflected electromagnetic radiation at a wavelength between about 660 nanometers and about 680 nanometers from the surface of the substrate during an electroless deposition process; and
a controller adapted to receive a signal from the detector and modify the electroless deposition process.

22. A system for monitoring an electroless deposition process comprising:
a plurality of chamber walls that enclose a processing region;
a substrate support disposed in the processing region having a substrate receiving surface;
an electromagnetic radiation source that is mounted proximate to the processing region and is adapted to emit electromagnetic radiation that strikes a surface of a substrate mounted on the substrate receiving surface;
a detector that detects the intensity of the reflected electromagnetic radiation from the surface of a substrate mounted on the substrate receiving surface during an electroless deposition process;
a controller adapted to receive a signal from the detector and modify the electroless deposition process; and
a memory, coupled to the controller, the memory comprising a computer-readable medium having a computer-readable program embodied therein for directing the operation of the electroless deposition system, the computer-readable program comprising:
computer instructions to control the electroless deposition system to:
(i) start processing;
(ii) collect and store into the memory the intensity of the reflected electromagnetic radiation data during the electroless deposition process;
(iii) compare the stored data with the collected data; and
(iv) modify the electroless deposition process when the collected data exceeds a threshold value.

23. The apparatus of claim 22, wherein the threshold value data is stored in the memory.

24. The apparatus of claim 22, wherein the electromagnetic radiation source emits electromagnetic radiation at wavelengths between about 200 nanometers and about 800 nanometers.

25. A method of controlling an electroless deposition process comprising:
positioning a substrate in an electroless deposition chamber;
rotating the substrate;
emitting electromagnetic radiation from a broadband light source onto a surface of the substrate, wherein the shape of the emitted electromagnetic radiation striking the surface of the substrate is substantially circular and the emitted electromagnetic radiation striking the surface of the substrate is positioned at a center of rotation of the substrate;
detecting an intensity of the electromagnetic radiation at one or more wavelengths that is reflected off a surface of a substrate during an electroless deposition process step by use of a detector; and
monitoring the intensity of the electromagnetic radiation at the one or more wavelengths to determine the status of the electroless deposition process.

26. The method of claim 25, wherein detecting an intensity of the electromagnetic radiation during the electroless deposition process further comprises detecting an intensity of the electromagnetic radiation during a first electroless deposition process step and a second electroless deposition process step.

27. The method of claim 25, wherein the one or more wavelengths is between about 200 nanometers and about 800 nanometers.

28. The method of claim 25, wherein the diameter of the substantially circular electromagnetic radiation striking the surface of the substrate is between about 2 micrometers and about 25 millimeters.

29. The method of claim 25, wherein the diameter of the substantially circular electromagnetic radiation striking the surface of the substrate is between about 1 millimeter and about 25 millimeters.

30. The method of claim 25, wherein the angle of the emitted electromagnetic radiation striking the surface of the substrate is substantially perpendicular to the substrate surface.

31. The method of claim 25, further comprising:
emitting electromagnetic radiation from a broadband light source in a direction that is not substantially perpendicular to the substrate surface; and
correcting the shape of the emitted electromagnetic radiation by use of an anamorphic prism so that the electromagnetic radiation striking the surface of the substrate is substantially circular in shape.

32. A method of controlling an electroless deposition process comprising:
delivering an electroless deposition fluid to a substrate in an electroless deposition chamber;
detecting the intensity of the electromagnetic radiation comprising:
rotating the substrate;
emitting electromagnetic radiation from a broadband light source onto a surface of the substrate, wherein the shape of the emitted electromagnetic radiation striking the surface of the substrate is substantially circular and the emitted electromagnetic radiation striking the surface of the substrate is positioned at a center of rotation of the substrate; and
detecting an intensity of the electromagnetic radiation at one or more wavelengths reflected off a surface of a substrate;
comparing the detected intensity of the electromagnetic radiation at a first time with a detected intensity of the electromagnetic radiation at a second time;
starting a deposition timer when the difference between the intensity of the electromagnetic radiation at the first time and the intensity of the electromagnetic radiation at the second time equals a process value; and
modifying an electroless deposition process step after the deposition timer has reached a defined period of time.

33. A method of sensing the initiation of the electroless deposition process comprising:
positioning a substrate in an electroless deposition chamber;
rotating the substrate;
emitting electromagnetic radiation from a broadband light source onto the a surface of the substrate, wherein the shape of the emitted electromagnetic radiation striking the surface of the substrate is substantially circular and the emitted electromagnetic radiation striking the surface of the substrate is positioned at a center of rotation of the substrate;
detecting an intensity of the electromagnetic radiation at one or more wavelengths that is reflected off a surface of a substrate at the start of the electroless deposition process by use of a detector;
detecting an intensity of the electromagnetic radiation at one or more wavelengths that is reflected off a surface of a substrate at a second time by use of a detector; and
modifying an electroless deposition process step when the change in the detected intensity at one or more wavelengths exceed a desired level.

34. An apparatus for monitoring an electroless deposition process comprising:
a plurality of chamber walls that enclose a processing region;
a substrate support disposed in the processing region having a substrate receiving surface;
a motor adapted to rotate the substrate support, wherein the substrate support has an axis of rotation that is substantially perpendicular to the substrate receiving surface;
an electromagnetic radiation source that is adapted to emit electromagnetic radiation that is substantially directed towards a center point on a substrate retained on the substrate receiving surface, wherein the center point is coincident with the axis of rotation;
a detector that is adapted to detect the intensity of reflected electromagnetic radiation from a surface of the substrate during an electroless deposition process; and
a controller adapted to receive a signal from the detector and modify the electroless deposition process.

35. An apparatus for monitoring an electroless deposition process comprising:
a plurality of chamber walls that enclose a processing region;
a substrate support disposed in the processing region having a substrate receiving surface;
a motor adapted to rotate the substrate support;
an electromagnetic radiation source that is adapted to emit electromagnetic radiation that strikes a substrate retained on the substrate receiving surface;
an anamorphic prism that is adapted to distort the shape of the electromagnetic radiation emitted from the electromagnetic radiation source;
a detector that is adapted to detect the intensity of reflected electromagnetic radiation from a surface of the substrate during an electroless deposition process; and
a controller adapted to receive a signal from the detector and modify the electroless deposition process.
